(19) United States
(12) Patent Application Publication
(10) Pub. No.: US 2009/0237944 A1
(43) Pub. Date: Sep. 24, 2009

(54) LIGHT FIXTURES WITH ADJUSTABLE ILLUMINATION ANGLE

(76) Inventor: Yulin Wu, Foshan (CN)

Correspondence Address: MATTHIAS SCHOLL, 14781 MEMORIAL DRIVE, SUITE 1319, HOUSTON, TX, 77079, US

(21) Appl. No.: 12/389,342

(22) Filed: Feb. 19, 2009

(30) Foreign Application Priority Data
Mar. 19, 2008 (CN) 200820045430.5

(51) Int. Cl. F21V 15/00

(52) U.S. Cl. 362/364

(57) ABSTRACT

A ceiling light fixture having an adjustable illumination angle, comprising: a fixed mount; a flexible mount; and a soft pipe; wherein the fixed mount is adapted for connecting to a ceiling; the flexible mount is flexibly connected to the fixed mount via the soft pipe; the flexible mount is adapted to receive a light-emitting element; and the soft pipe exhibits plastic deformation behavior and is adapted to bend and stretch axially. The soft pipe is capable of bending and stretching axially and therefore the illumination angle can be freely adjusted.

### CROSS-REFERENCE TO RELATED APPLICATIONS

Pursuant to 35 U.S.C. § 119 and the Paris Convention Treaty, this application claims the benefit of Chinese Patent Application No. 200820045430.5 filed Mar. 19, 2008, the contents of which are incorporated herein by reference.

### BACKGROUND OF THE INVENTION

1. Field of the Invention

The invention relates to light fixtures, and more particularly to ceiling and wall light fixtures with an adjustable illumination angle.

2. Description of the Related Art

At present, decorating and wall light fixtures are widely used. However, a problem with conventional light fixtures is that illumination angles thereof cannot be freely adjusted

### SUMMARY OF THE INVENTION

In view of the above-described problems, it is an objective of the invention to provide a ceiling light fixture with an adjustable illumination angle. It is another objective of the invention to provide a wall light fixture with an adjustable illumination angle.

In order to achieve the above objectives, in accordance with one embodiment of the invention, provided is a ceiling light fixture having an adjustable illumination angle, comprising: a fixed mount; a flexible mount; and a soft pipe; wherein the fixed mount is adapted for connecting to a ceiling; the flexible mount is flexibly connected to the fixed mount via the soft pipe; the flexible mount is adapted to receive a light-emitting element; and the soft pipe exhibits plastic deformation behavior and is adapted to bend and stretch axially.

In a class of this embodiment or in another embodiment, a pair of cylinders is disposed one on the fixed mount and one on the flexible mount.

In a class of this embodiment or in another embodiment, the soft pipe is connected with the cylinder.

In a class of this embodiment or in another embodiment, the wall surface of the cylinder and that of the soft pipe tightly form a waterproof structure.

In a class of this embodiment or in another embodiment, the soft pipe is connected at one end to the fixed mount and at another end to the flexible mount via adhesion or welding.

In a class of this embodiment or in another embodiment, the soft pipe is connected at one end to the fixed mount and at another end to the flexible mount via a fastener ring.

In accordance with another embodiment of the invention, provided is a wall light fixture with an adjustable illumination angle, comprising: a fixed mount; a flexible mount; and a soft pipe; wherein the fixed mount is adapted for connecting to a wall; the flexible mount is flexibly connected to the fixed mount via the soft pipe; the flexible mount is adapted to receive a light-emitting element; and the soft pipe exhibits plastic deformation behavior and is adapted to bend and stretch axially.

In a class of this embodiment or in another embodiment, a pair of cylinders is disposed one on the fixed mount and one on the flexible mount.

In a class of this embodiment or in another embodiment, the soft pipe is connected with the cylinder.

In a class of this embodiment or in another embodiment, the wall surface of the cylinder and that of the soft pipe tightly form a waterproof structure.

In a class of this embodiment or in another embodiment, the soft pipe is connected to at one end to the fixed mount and at another end the flexible mount via adhesion or welding.

In a class of this embodiment or in another embodiment, the soft pipe is connected to at one end to the fixed mount and at another end to the flexible mount via a fastener ring.

One advantage of the invention is that the soft pipe is capable of bending and stretching axially, and therefore the illumination angle can be freely adjusted.

### BRIEF DESCRIPTION OF THE DRAWINGS

The light fixture, according to the invention, is presented, by way of the example only, in the drawings, in which:

FIG. 1 is a schematic diagram of a ceiling light fixture of an exemplary embodiment of the invention;

FIG. 2 illustrates a soft pipe in a bent state;

FIG. 3 illustrates a soft pipe in an axial-stretched state;

FIG. 4 illustrates a waterproof structure formed by a cylinder and a soft pipe of an exemplary embodiment of the invention;

FIG. 5 illustrates a waterproof structure formed by a cylinder and a soft pipe of another exemplary embodiment of the invention; and

FIG. 6 is a schematic diagram of a wall light fixture according to an exemplary embodiment of the invention.

### DETAILED DESCRIPTION OF THE EMBODIMENTS

Detailed description will be given below in conjunction with accompany drawings.

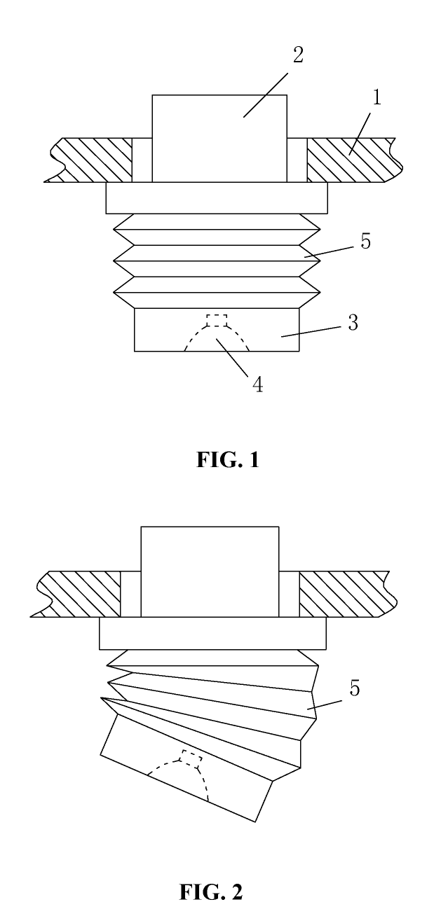

As shown in FIG. 1, a wall light fixture comprises: a fixed mount 2, a flexible mount 3, a light-emitting element 4, and a soft pipe 5. The fixed mount 2 is connected to ceiling 1. The flexible mount 3 is flexibly connected to the fixed mount 2 via the soft pipe 5. The light-emitting element 4 is disposed on the flexible mount 3.

In this embodiment, the light-emitting element 4 is a bulb, an LED light, etc., and the soft pipe 5 is a thin pipe made of plastics or aluminum exhibiting plastic deformation behavior of bending and stretching axially, and is connected to the fixed mount 2 and the flexible mount 3 via adhesion or welding. If the ceiling 1 has an opening, the fixed mount 2 is received in the opening, and if the ceiling 1 has no opening, the fixed mount 2 is affixed therebelow.

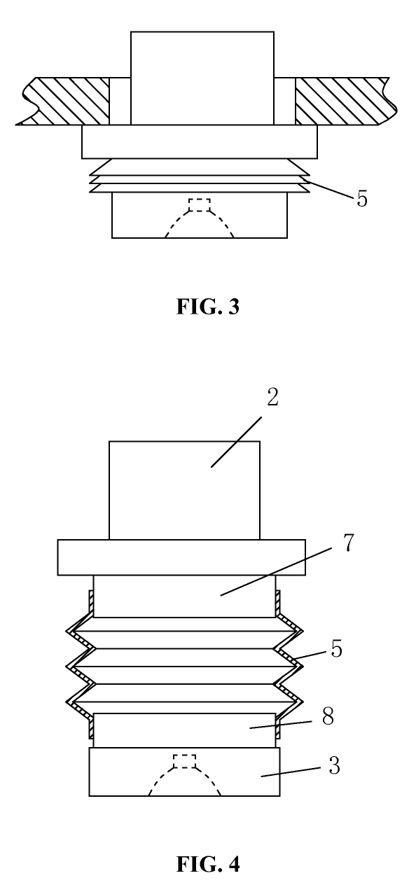

As shown in FIG. 2, when external force is axially applied to the soft pipe 5, the soft pipe 5 is shortened at one side, and the illumination angle is adjusted. As shown in FIG. 3, when the external force is applied in a different direction, the soft pipe 5 returns to its original state.

As shown in FIG. 4, a pair of cylinders 7 and 8 are disposed on the fixed mount 2 and the flexible mount 3, respectively, and connected with the soft pipe 5. Wall surface of the cylinders 7 and 8 and that of the soft pipe 5 tightly form a waterproof structure, so as to isolate vapor. The cylinders 7 and 8 can be disposed outside or inside the soft pipe 5. The soft pipe 5 is connected to each of the cylinders 7 and 8 via adhesion so as to form the waterproof structure.

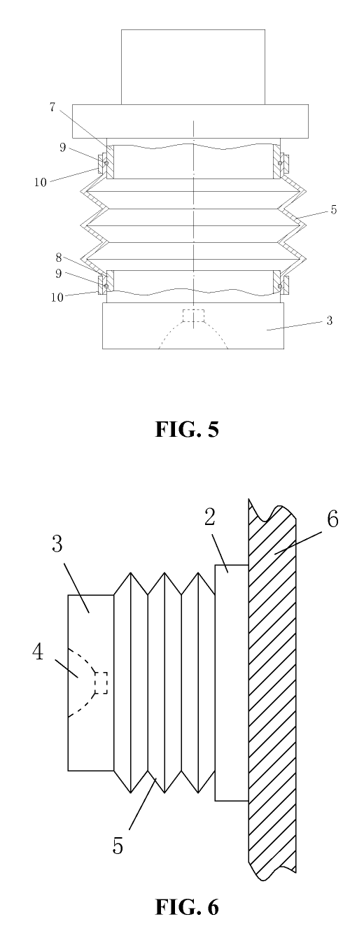

As shown in FIG. 5, a rubber ring 9 is disposed between the soft pipe 5 and each of the cylinders 7 and 8. A pair of fastener rings 10 is disposed on the cylinders 7 and 8 and tightly connects the soft pipe 5 thereto, so as to form a waterproof structure. The fastener rings 10 can be fixed to the cylinders 7 and 8 using screws.

As shown in FIG. 6, a wall light fixture comprises a fixed mount 2, a flexible mount 3, a light-emitting element 4, and a soft pipe 5. The fixed mount 2 is connected to wall 6. The flexible mount 3 is flexibly connected to the fixed mount 2 via the soft pipe 5. All components and operation principle of this embodiment are the same as those described above, and will not be repeated hereinafter.

This invention is not to be limited to the specific embodiments disclosed herein and modifications for various applications and other embodiments are intended to be included within the scope of the appended claims. While this invention has been described in connection with particular examples thereof, the true scope of the invention should not be so limited since other modifications will become apparent to the skilled practitioner upon a study of the drawings, specification, and following claims.

The invention claimed is:

1. A ceiling light fixture having an adjustable illumination angle, comprising:
a fixed mount;
a flexible mount; and
a soft pipe;
wherein
said fixed mount is adapted for connecting to a ceiling;
said flexible mount is flexibly connected to said fixed mount via said soft pipe;
said flexible mount is adapted to receive a light-emitting element; and
said soft pipe exhibits plastic deformation behavior and is adapted to bend and stretch axially.

2. The ceiling light fixture of claim 1, wherein a pair of cylinders is disposed, one on said fixed mount and one on said flexible mount.

3. The ceiling light fixture of claim 2, wherein said soft pipe is connected with said cylinder.

4. The ceiling light fixture of claim 2, wherein wall surface of said cylinder and that of said soft pipe tightly form a waterproof structure.

5. The ceiling light fixture of claim 1, wherein said soft pipe is connected to each of said fixed mount and said flexible mount via adhesion or welding.

6. The ceiling light fixture of claim 1, wherein said soft pipe is connected to each of said fixed mount and said flexible mount via a fastener ring.

7. A wall light fixture having an adjustable illumination angle, comprising:
a fixed mount;
a flexible mount; and
a soft pipe;
wherein
said fixed mount is adapted for connecting to a wall;
said flexible mount is flexibly connected to said fixed mount via said soft pipe;
said flexible mount is adapted to receive a light-emitting element; and
said soft pipe exhibits plastic deformation behavior and is adapted to bend and stretch axially.

8. The wall light fixture of claim 7, wherein a pair of cylinders is disposed one on said fixed mount and one on said flexible mount.

9. The wall light fixture of claim 8, wherein said soft pipe is connected with said cylinder.

10. The wall light fixture of claim 8, wherein wall surface of said cylinder and that of said soft pipe tightly form a waterproof structure.

11. The wall light fixture of claim 7, wherein said soft pipe is connected to each of said fixed mount and said flexible mount via adhesion or welding.

12. The wall light fixture of claim 7, wherein said soft pipe is connected to each of said fixed mount and said flexible mount via a fastener ring.
